(19) United States
(12) Patent Application Publication
(10) Pub. No.: US 2020/0410537 A1
(43) Pub. Date: Dec. 31, 2020

(54) KEYWORD DISCOVERY SYSTEM

(71) Applicant: Airbnb, Inc., San Francisco, CA (US)

(72) Inventors: Ye Wang, Belmont, CA (US); Tao Cui, Arlington, CA (US); Yi Ding, San Francisco, CA (US); Fatima Husain, San Francisco, CA (US)

(21) Appl. No.: 16/451,422

(22) Filed: Jun. 25, 2019

(51) Int. Cl. G06Q 30/02; G06F 16/903; G06F 16/93; G06F 16/901

(52) U.S. Cl. CPC G06Q 30/0256; G06F 16/902; G06F 16/93; G06F 16/90344

(57) ABSTRACT

Systems and methods are provided for generating a plurality of documents for a seed keyword, generating candidate keywords from extracted words of the plurality of documents, ranking the candidate keywords by a frequency with which each candidate keyword appears in a particular document of the plurality of documents and a frequency with which each candidate keyword appears across all of the plurality of documents, and determining a selection of the ranked candidate words to store as selected keywords.

### BACKGROUND

A keyword is a term used to refer to one word or multiple words (e.g., a phrase) that can be used to describe a topic of a document, such as a webpage or other document. A keyword is used to find content via a search engine or other mechanism for searching content. A keyword can also be used to rank results of a search. Moreover, a keyword can be used to trigger content, such as an advertisement, related products or services, or the like.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a flow chart illustrating aspects of a method, for discovering new keywords, according to some example embodiments.

FIG. 3 illustrates example search results from a query using a seed or selected keyword, according to some example embodiments.

FIG. 4 illustrates an example list of ranked candidate keywords, according to some example embodiments.

FIG. 5 illustrates a bipartite graph and datastores, according to some example embodiments.

FIG. 6 is a flow chart illustrating aspects of a method, for generating a similarity ratio for a pair of keywords, according to some example embodiments.

FIG. 7 is a flow chart illustrating aspects of a method, for generating a direction graph estimate in an asymmetrical scenario, according to some example embodiments.

FIG. 8 is a block diagram illustrating an example of a software architecture that may be installed on a machine, according to some example embodiments.

FIG. 9 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

Example systems and methods described herein relate to keyword discovery. Choosing a useful keyword is important to drive more users to view particular content, correctly rank results of a search to provide more accurate content to a user, trigger related content, and so forth. A keyword that is not useful may result in less views or visitors for particular content, irrelevant content to be returned in a search, trigger of content that is not of interest to a user, and so forth.

Finding useful keywords is challenging. In search engine marketing, for example, an entity needs a deep understanding of its business to determine whether a keyword is relevant and also a way to develop new ideas to expand more keyword categories. Moreover, after determining new keywords, the entity needs to determine a click likelihood and estimated cost for the new keywords. The more relevant keywords an entity can come up with, the more user searches that can trigger the entity ads. While an entity can come up with a handful of useful keywords to start, it is very difficult to generate any new keywords beyond the initial keywords, and any that may be generated are likely already covered by the initial keywords. An entity can use data from search engine keyword reports, however, it is not practical, or even possible, to review each and every search in such reports. Moreover, any new keywords that an entity can derive from such a report are going to be similar to the existing keywords, and thus likely covered already by the existing keywords.

Example embodiments described herein provide systems and methods for discovering new keywords to increase the quantity and quality of relevant keywords. For example, example embodiments allow for a computing system to start with a seed keyword and then perform a keyword-to-document transformation that generates a list of high-quality documents and follows with a document-to-keyword transformation to produce more relevant keywords. The loop goes on until relevant keywords are exhausted or a document space is exhausted. Example embodiments further allow for predicted metrics estimations for the newly generated keywords, based on known actual metrics for existing keywords.

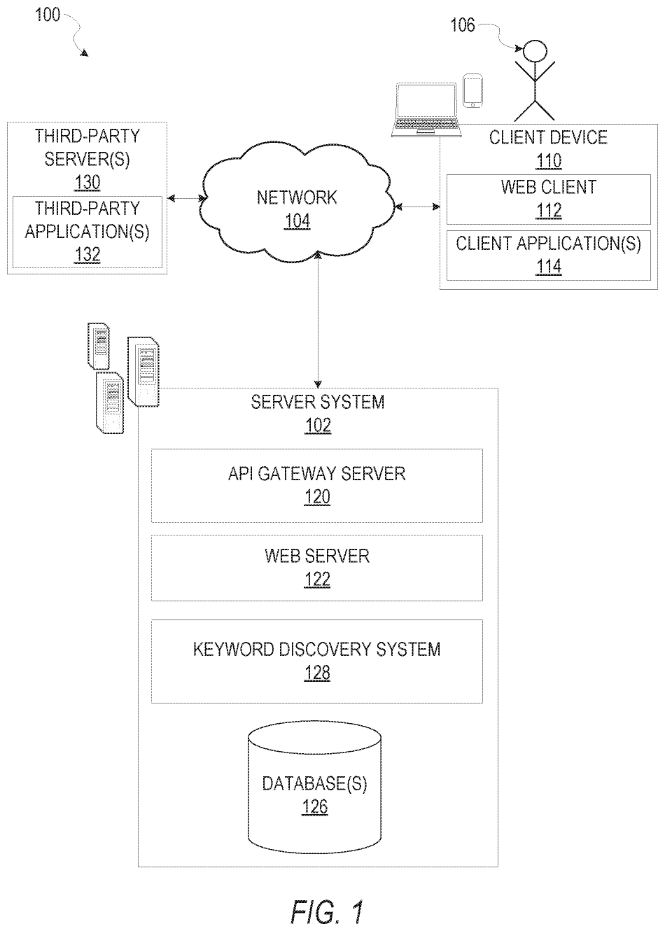

FIG. 1 is a block diagram illustrating a networked system 100, according to some example embodiments. The system 100 includes one or more client devices such as a client device 110. The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronic system, game console, set-top box, computer in a vehicle, or any other communication device that a user may utilize to access the networked system 100. In some embodiments, the client device 110 comprises a display module (not shown) to display information (e.g., in the form of user interfaces). In further embodiments, the client device 110 comprises one or more of touch screens, accelerometers, gyroscopes, cameras, microphones, Global Positioning System (GPS) devices, and so forth. The client device 110 may be a device of a user that is used to request and receive reservation information, accommodation information, loan information, income verification, and so forth.

One or more users 106 may be a person, a machine, or other means of interacting with the client device 110. In example embodiments, the user 106 may not be part of the system 100, but may interact with the system 100 via the client device 110 or other means. For instance, the user 106 may provide input (e.g., voice, touch screen input, alphanumeric input, etc.) to the client device 110 and the input may be communicated to other entities in the system 100 (e.g., third-party servers 130, server system 102, etc.) via a network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 further includes a network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WIFI network, a WiMax network, another type of network, or a combination of two or more such networks.

The client device 110 accesses the various data and applications provided by other entities in the system 100 via a web client 112 (e.g., a browser, such as the Internet Explorer® browser developed by Microsoft® Corporation of Redmond, Wash. State) or one or more client applications 114. The client device 110 includes one or more client applications 114 (also referred to as “apps”) such as, but not limited to, a web browser, a messaging application, an electronic mail (email) application, an e-commerce application, a mapping or location application, a reservation application, a search engine, and the like.

In some embodiments, one or more client applications 114 are included in a given client device 110 and configured to locally provide the user interface and at least some of the functionalities, with the client application 114 configured to communicate with other entities in the system 100 (e.g., the third-party servers 130, server system 102, etc.), on an as-needed basis, for data and/or processing capabilities not locally available (e.g., to access reservation information or listing information, to request data, to authenticate a user 106, to verify a method of payment, to verify income, to search for and retrieve content (e.g., documents)). Conversely, one or more client applications 114 may not be included in the client device 110, and then the client device 110 may use its web browser to access the one or more applications hosted on other entities in the system 100 (e.g., the third-party servers 130, server system 102).

The system 100 further includes one or more third-party servers 130. The one or more third-party servers 130 includes one or more third-party application(s) 132. The one or more third-party application(s) 132, executing on the third-party server(s) 130, interact with the server system 102 via an application programming interface (API) gateway server 120 via a programmatic interface provided by the API gateway server 120. For example, one or more of the third-party applications 132 requests and utilizes information from the server system 102 via the API gateway server 120 to support one or more features or functions on a website hosted by a third party or an application hosted by the third party. The third-party website or application 132, for example, provide various functionality that is supported by relevant functionality and data in the server system 102 (e.g., keyword discovery and related functionality).

The server system 102 provides server-side functionality via the network 104 (e.g., the internet or a wide area network (WAN)) to one or more third-party servers 130 and/or one or more client devices 110. The server system 102 may be a cloud computing environment, according to some example embodiments. The server system 102, and any servers associated with the server system 102, may be associated with a cloud-based application, in one example embodiment.

The server system 102 includes an application programming interface (API) gateway server 120, a web server 122, and a keyword discovery system 128, which may be communicatively coupled with one or more databases 126 or other forms of data stores.

The one or more databases 126 may be one or more storage devices that store data related to the keyword discovery system 128 and other systems or data. The one or more databases 126 may further store information related to third-party servers 130, third-party applications 132, client devices 110, client applications 114, users 106, and so forth. The one or more databases 126 may be implemented using any suitable database management system such as MySQL, PostgreSQL, Microsoft SQL Server, Oracle, SAP, IBM DB2, or the like. The one or more databases 126 may include cloud-based storage, in some embodiments.

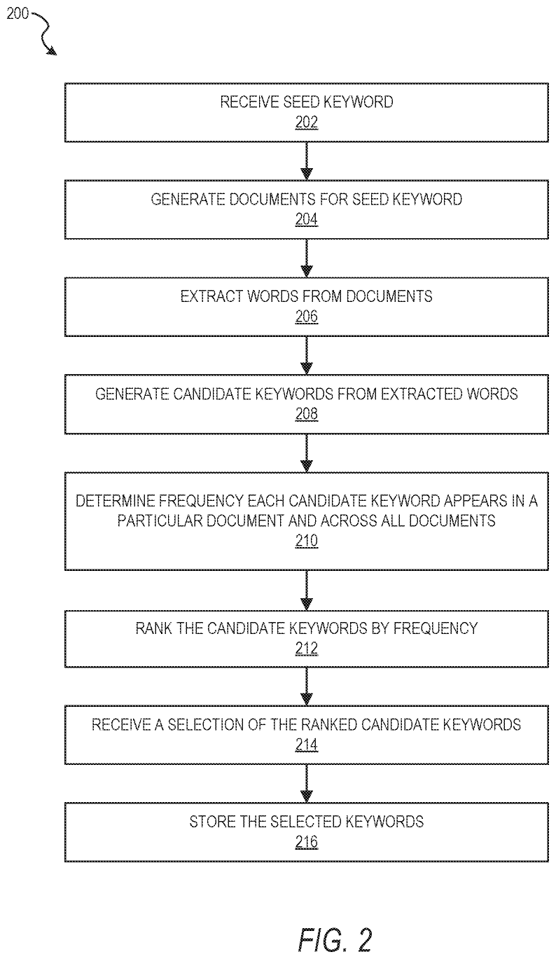

FIG. 2 is a flow chart illustrating aspects of a method 200, for discovering new keywords, according to some example embodiments. For illustrative purposes, the method 200 is described with respect to the networked system 100 of FIG. 1. It is to be understood that the method 200 may be practiced with other system configurations in other embodiments.

In operation 202, a computing system (e.g., the server system 102, keyword discovery system 128) receives a seed keyword. For example, the computing system receives the seed keyword via a computing device (e.g., client device 110) that is entered by a user 106, the computing system receives the seed keyword via third-party server 130 or third-party application 132, or the like. In another example, the computing system accesses one or more datastores (e.g., database 126) to retrieve the seed keyword (which can be a stored as a selected keyword as described below).

In operation 204, the computing system generates documents for the seed keyword. For example, the computing system uses the seed keyword as a query in one or more search engines to generate a plurality of documents for the seed keyword. The search may be conducted on public documents (e.g., the Internet), private documents (e.g., internal to a particular entity conducting the search), on specified websites or domains (e.g., a competitor's website, a related industry website), and so forth.

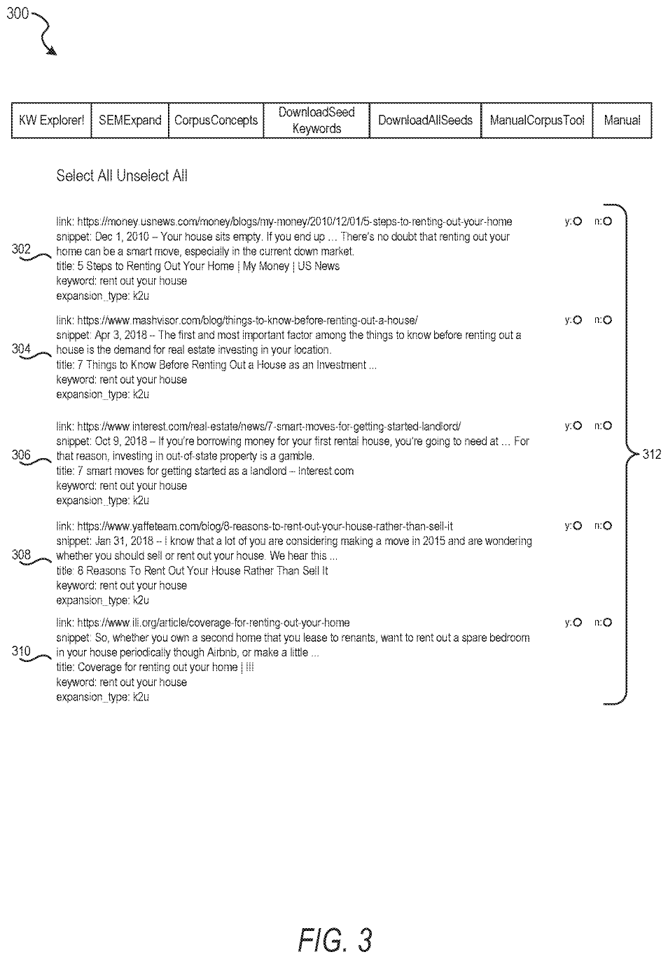

In one example embodiment, the computing system provides the seed keyword to a search engine and receives a list of documents that result from a search for content related to the seed keyword. FIG. 3 illustrates example search results 300 from a query using a seed keyword (or selected keyword). In the example in FIG. 3, the seed keyword used for the query was “rent out your house” and the results list five documents (302, 304, 306, 308, and 310). In this example, the documents are websites or webpages. It is to be understood that the documents can be in other forms, such as a Word document, pdf, image, video, and so forth. In one example embodiment, the result list of documents is in a ranked order with a most relevant document listed first, a next relevant document listed second, and so forth.

Optionally, in one example embodiment, the results list of search results can be provided to a computing device (e.g., client device 110) so that a user can select documents that are relevant and documents that are irrelevant, for example using yes or no options 312 next to each of the documents. The computing system receives the selection of documents that are relevant and the selection of documents that are irrelevant and can store these selections in one or more databases 126.

In some example embodiments, one or more search results may comprise a large number of documents (e.g., 100, 500). In one example embodiment, the computing system selects a subset of the documents (e.g., 10, 20, 40) comprising the highest ranked documents (e.g., top 10, top 20, top 40) to further process.

Returning to FIG. 2, in operation 206, the computing system extracts words from the documents. For example, the computing system analyzes each document (e.g., parses the document) to extract words for each sentence in each document (e.g., via a natural language algorithm or method). For example, the computing system can use spaCy dependency parser or related technology for extracting words from documents. In one example, the computing system extracts nouns and verbs from each sentence. In another example, the computing system selects other predetermined types of words for each sentence.

In operation 208, the computing system generates candidate keywords from the extracted words. For example, the computing system extracts (e.g., retrieves) the words (e.g., nouns and verbs) from each sentence in a document Di and puts them in a set S. For example, for the sentence “I had a good day,” the computing system could extract (had, a, good, day), or (had, good, day), or the like, and add those words to the set S.

For k=1 to m, the computing system takes k words from the set S. In one example, k=2, in another example, k=3, but k can be another value in other examples. From this the computing system generates a k-tuple (or other data structure) comprising one or more of the extracted words (e.g., the 2 or 3 words taken from set S). Each k-tuple is a candidate keyword.

In operation 210, the computing system determines a frequency with which each candidate keyword appears in a particular document. In this way, the computing system can determine candidate keywords that appear frequently inside a particular document. For example, for each k-tuple (w1, . . . , wk), where w indicates a word, the computing system computes Ai, which is the frequency with which each candidate keyword (each k-tuple) appears in the document. For example, the computing system computes Ai=count(w1, Di)* . . . *count(wk, Di), where count (w1, Di) is the number of sentences containing w1 in Di (e.g., the frequency with which the candidate keyword appears in the particular document Di).

The computing system also computes Bi, which is the number of sentences containing all k words. For example, the computing system computes Bi=count(w1, w2, . . . , wk, Di), where count(w1, w2, . . . , wk, Di) is the number of sentences containing all k words.

The computing system computes Ai and Bi for each document and then computes t-statistics, chi-square statistics, or the like, and orders the k-tuples (e.g., candidate keywords) by the statistics. In one example, the computing system selects a subset of the total k-tuples (e.g., a subset of candidate keywords) that have statistics over a predefined threshold (e.g., the top k-tuples determined by the predefined threshold). In one example embodiment, this is to compute Pr(x,y)/Pr(x)Pr(y) to test the interdependence of the candidate keywords.

In operation 212, the computing system ranks the candidate keywords (or subset of candidate keywords) by frequency (e.g., ranks the candidate keywords by the frequency with which each candidate keyword appears in a particular document and the frequency with which the candidate keyword appears across all documents). For example, for each k in (1, . . . , m) the computing system generates the k-tuples and computes term frequency document frequency (tfdf), term frequency inverse document frequency (tfidf), or another metric for each k-tuple, and selects the k-tuples with the top tfdf (for example) values. A term frequency is how frequently a candidate keyword appears in a document and a document frequency is how often a candidate keyword appears across the different documents. Note that a k-tuple with a low frequency in each document may have a high tfdf and may be selected in the end.

In one example embodiment, the computing system provides the ranked candidate keywords to a computing device (e.g., client device 110 or third-party server 130). In one example, before sending the ranked candidate keywords to the computing device, the computing system can determine whether any of the candidate keywords are highly semantically similar (e.g., using word embeddings, bag of words similarities for search results, or other techniques) to a known irrelevant keyword or known relevant keyword. The computing system can discard any candidate keywords that are highly semantically similar to known irrelevant keywords and automatically select candidate keywords highly semantically similar to known relevant keywords (e.g., as selected keywords). In this example, the computing system can then provide only the remaining ranked candidate keywords to the computing device, such that only new unique keywords are displayed to be considered by a user. The ranked candidate keywords can be displayed in a user interface (UI) on the computing device.

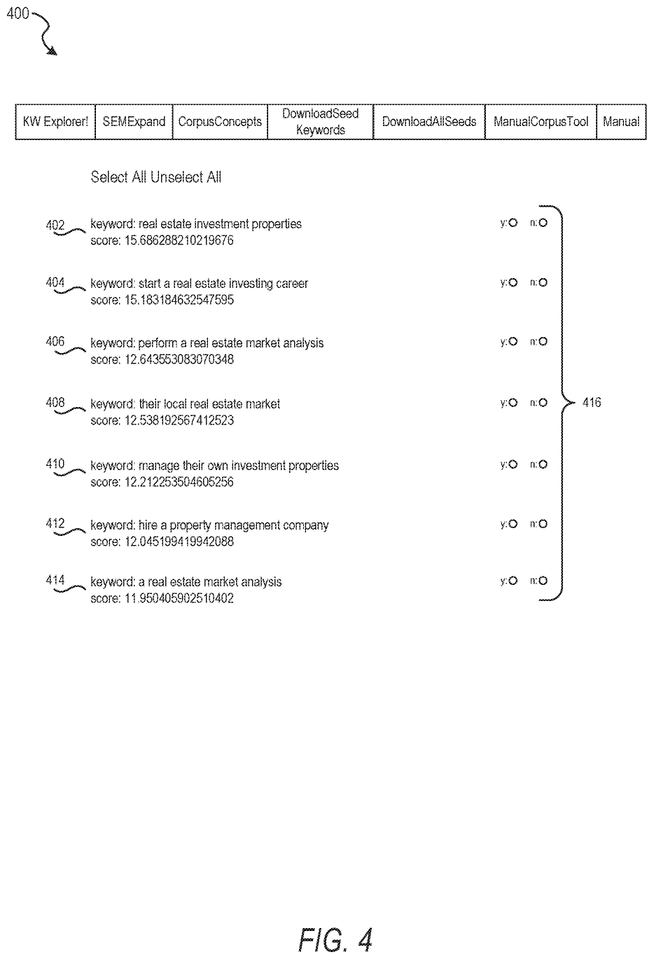

FIG. 4 illustrates an example UI 400 of a list of ranked candidate keywords 402, 404, 406, 408, 410, 412, and 414. In this example, each keyword is listed with a corresponding score. Also, there are yes and no options 416 next to each keyword 402-414 that allows a user to select whether the candidate keyword should be stored as a selected keyword or whether the candidate keyword should be discarded.

Returning to FIG. 2, in operation 214, the computing system receives a selection of the ranked candidate keywords to be stored as selected keywords, from the computing device. In operation 216, the computing system stores the selected keywords (e.g., as relevant keywords in one or more databases 126). In one example embodiment, the computing system also receives the ranked candidate keywords that were selected to be discarded. The computing system stores the discarded candidate keywords (e.g., in an irrelevant keywords database 126).

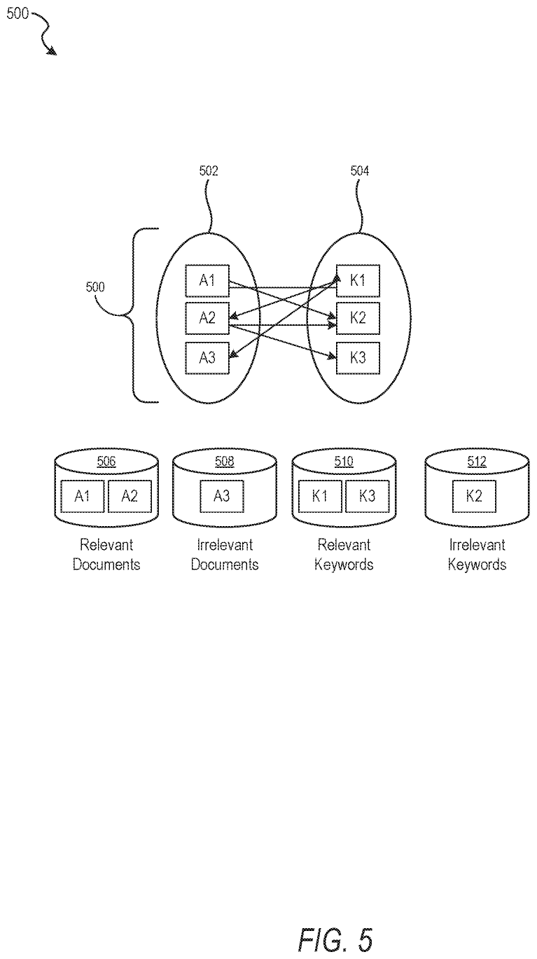

In one example, the expansion process of generating keywords can be depicted with a bipartite graph 500, as shown in FIG. 5, where one side 502 of the bipartite graph 500 represents the document or article set (A1, A2, A3) and the other side 504 representing the keyword set (K1, K2, K3). In the example in FIG. 5, there are two relevant documents A1 and A2 and one irrelevant document A3, and two relevant keywords K1 and K3 and one irrelevant keyword K2. In this example, the computing system initially starts with A1 and generates two keywords K1 and K2. These keywords are provided to a computing device where K1 is selected as relevant and K2 is selected as irrelevant. The computing system continues the process to expand K1 (e.g., using selected keyword K1 as a seed keyword in the process) to get A2 and A3. The process between the document set and the keyword set can continue until the incremental gain is small. The relevant documents are stored in datastore 506 and the irrelevant documents are stored in datastore 508. The relevant keywords (e.g., selected keywords) are stored in datastore 510 and the irrelevant keywords are stored in datastore 512.

In one example, keyword similarity sim(ki, kj) is determined by the similarity of the document sets returned by a search engine. It is also noted that as the computing system goes through the process multiple times, a majority of the keywords will be labeled and thus, there will be little human interaction needed. For example, the process in FIG. 2 can be repeated for each selected keyword as the seed keyword. For example, for each of the selected keywords, the following operations are repeated until a predetermined number of interactions is reached or until a predetermined number of total selected keywords is reached. The computing system uses the selected keyword as a query in one or more search engines to generate a plurality of documents for the selected keyword, analyzes each document of the plurality of documents to extract words for each sentence in each document of the plurality of documents, and generates candidate keywords from the extracted words. The computing device determines a frequency with which each candidate keyword appears in a particular document of the plurality of documents and a frequency with which each candidate keyword appears across all of the plurality of documents, and ranks the candidate keywords by the frequency with which each candidate keyword appears in a particular document of the plurality of documents and the frequency with which each candidate keyword appears across all of the plurality of documents. The computing device provides the ranked candidate keywords to a computing device (if needed) and receives a selection of the ranked candidate keywords to store as selected keywords. In an alternate embodiment, the computing system can determine whether the candidate keywords are highly semantically similar to known relevant or irrelevant keywords and provide fewer candidate keywords or not need to provide any at all to the computing device. The computing system stores the selected keywords. These operations are all explained in further detail above with respect to FIG. 2.

For each selected keyword, the computing system can generate an estimated clickthrough rate, traffic volume, cost of the keyword, or other measure, based on actual clickthrough rate, traffic volume, or other metric, for existing keywords. Existing keywords are keywords that have been in use and thus, have actual data for clickthrough rates, traffic volume, or other metrics. The selected keywords are newly generated keywords that are not yet in use, and thus do not have any actual data associated with them. In one example embodiment, the computing system uses the existing keywords and data for the existing keywords to estimate these values for the selected keywords. To estimate these values, the computing system computes a correlation or similarity between each selected keyword and each existing keyword.

One way to compute the correlation is to compute the similarity between the keywords themselves (e.g., between each selected keyword and each existing keyword). The select keyword and existing keyword, however, may be short, and thus, it is difficult to accurately compute a similarity in this way. Instead, the computing system uses documents generated in a search using the selected keywords and existing keywords to compute the correlation between each selected keyword and each existing keyword. This computed correlation (e.g., similarity ratio) is then used to generate a predicted clickthrough rate, traffic volume, and the like, as explained in further detail below.

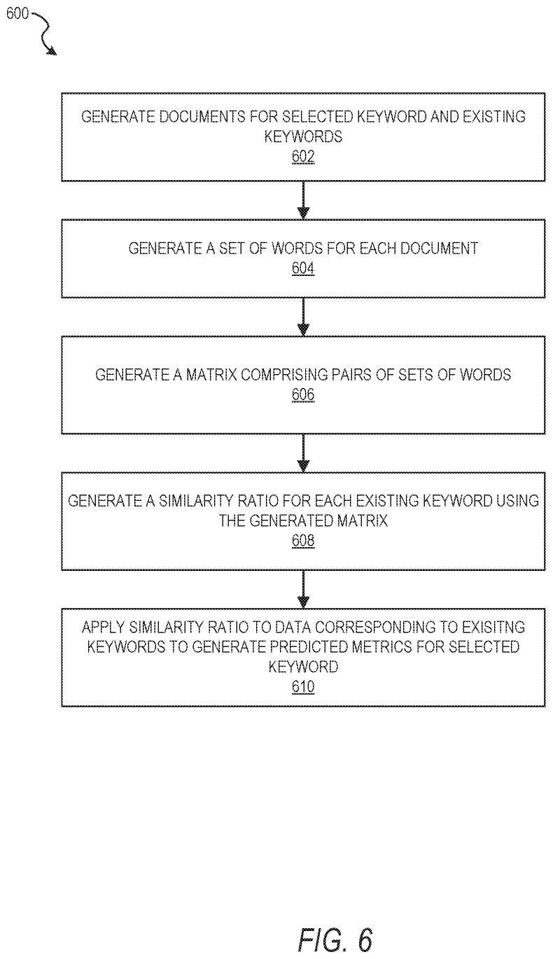

FIG. 6 is a flow chart illustrating aspects of a method 600 for generating a similarity ratio for a plurality of pairs of keywords, each pair comprising a selected keyword (e.g., a new keyword) and an existing keyword, according to some example embodiments. For illustrative purposes, the method 600 is described with respect to the networked system 100 of FIG. 1. It is to be understood that the method 600 may be practiced with other system configurations in other embodiments.

In operation 602, the computing system generates a set of documents for a selected keyword and a set of documents for each of a plurality of existing keywords. For example, as explained above, the computing system uses the selected keyword as a query in one or more search engines to generate a plurality of documents for the selected keyword. The computing system also uses each of the existing keywords as a query in one or more search engines to generate a plurality of documents for each existing keyword. The search may be conducted on public documents (e.g., the Internet), private documents (e.g., internal to a particular entity conducting the search), on specified websites or domains (e.g., a competitor's website, a related industry website), and so forth. The computing system will then find a correlation between the set of documents for the selected keyword and each set of the sets of documents for the existing keywords. In one example, the computing system only uses the top ranked documents in the search results, for example, the first ten, twenty, or forty documents listed in the search results.

In operation 604, the computing system generates a set of words for each document for the selected keyword and a set of words for each document of the set of documents for each of the plurality of existing keywords. For example, the computing system analyzes each document (e.g., parses the document) to extract words for each sentence in each document (e.g., via a natural language algorithm or method), as explained in further detail above.

In operation 606, the computing system generates a matrix comprising pairs of sets of words. For example, each pair comprises the set of words for the selected keyword and a set of words for an existing keyword. Using a simple example with just one select keyword and one existing keyword, a set of documents D1 for a selected keyword w1 comprises forty documents D1-1 to D1-40, and a set of documents D2 for existing keyword w2 comprises forty documents D2-1 to D2-40. The computing system generates a 40×40 matrix with pairs of sets of words for each pair of documents. For example, one pair is the set of words for D1-1 and D2-1, another pair is the set of words for D1-2 and D2-2, and so forth. This same method is used for all the existing keywords.

In operation 608, the computing system generates a similarity ratio for the selected keyword for each existing keyword, using the generated matrix. For example, the computing system computes the correlation between every pair in the matrix using Jaccard similarity, cosine correlation, or other method for computing a correlation. Using the example above, the correlation between selected keyword w1 and existing keyword w2 is the average of all the correlations of the pairs in the matrix. In one example, the similarity ratio is a value from 0 to 1 (e.g., 0.99, 0.01, 0.1).

In operation 610, the computing system applies the similarity ratio to data corresponding to existing keywords to generate predicted metrics for the selected keyword. The data corresponding to the existing keywords can be stored in one or more datastores (e.g., database 126) and the computing system can access the one or more datastores to retrieve the data associated with each of the existing keywords.

In one example, the computing system predicts a clickthrough rate and traffic volume for the selected keyword. In one example, the clickthrough rate is the number of users that selected (e.g., clicked on) an ad that was triggered by the existing keyword. In another example, the clickthrough rate is the percentage of users who viewed the ad and then actually went on to select (e.g., click on) the ad (e.g., total clicks on ad/total impressions=clickthrough rate).

To predict the clickthrough rate or traffic volume for the selected keyword, the computing system, for each existing keyword, applies the similarity ratio for the first selected keyword to an actual clickthrough rate and an actual traffic volume corresponding to the existing keyword to generate a predicted clickthrough rate and predicted traffic volume for the selected keyword. To use a simple example, assuming a similarity ratio for selected keyword w1 and existing keyword w2 is 0.99 and the actual clickthrough rate for existing keyword w2 is 10,000, the predicted clickthrough rate is 9,900 (e.g., 10,000×0.99). Using this same example, if an actual traffic volume for existing keyword w2 is 50,000, the predicted traffic volume is 49,500 (e.g., 50,000×0.99).

In one example embodiment, to predict the clickthrough rate or traffic volume, as examples, the computing system applies the similarity ratio for the selected keyword and each existing keyword to the clickthrough rate or traffic volume estimate for each existing keyword. For example, let R denote a correlation matrix of existing keywords and c be a cross-correlation vector between all existing keywords and a selected keyword. The computing system estimates the clickthrough rate as:

c^{T}R⁻¹CTR

Likewise, the computing system estimates the traffic volume as:

c^{T}R⁻¹Volume

Where CTR is a vector containing clickthrough rates from existing keywords and Volume is a vector containing traffic volume rates from existing keywords.

The computing system can store the predicted clickthrough rate and predicted traffic volume for the selected keyword. In one example embodiment, the computing system ranks the selected keywords by predicted clickthrough rate and predicted traffic volume. This ranked list can be used to determine the top selected keywords to use for an ad campaign or other use case scenario. In one example embodiment, the computing system can provide the top selected keywords (e.g., based on a threshold value or number of keywords) to a computing device to be used in the ad campaign or other use case scenario. In this way, only quality keywords can be used for the ad campaign or other use case scenario.

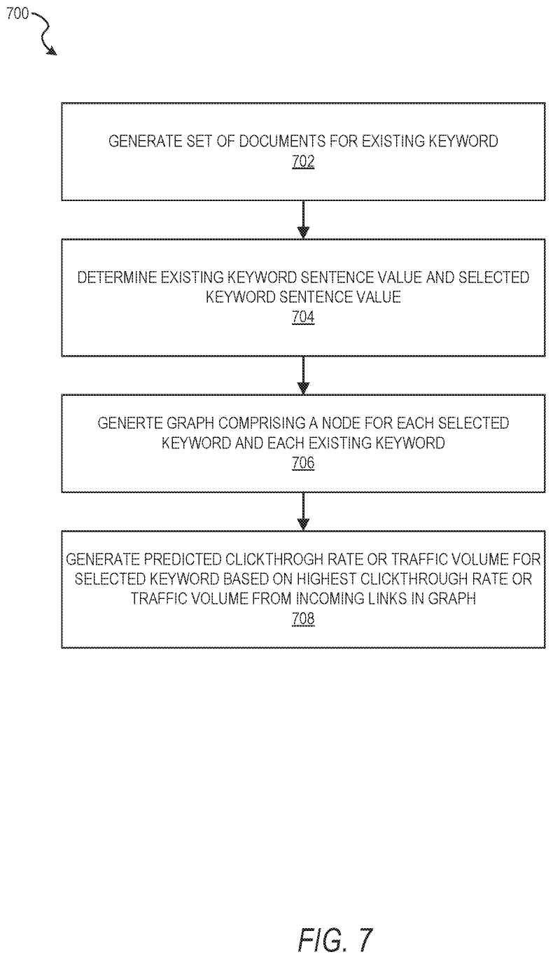

The method described above works well in the scenario where a selected keyword and an existing keyword are symmetrical. This means that the selected keyword is related to the existing keyword and vice versa, the existing keyword is related to the selected keyword. However, not all selected keywords and existing keywords may be symmetrical. For example, “temporary rental host” may be related to “rental property” but “rental property” may not always be related to “temporary rental host.” When a selected keyword and an existing keyword cannot be inferred form each other, they are asymmetrical. In one example embodiment, a different approach can be used for the asymmetrical scenario to find the probability of inferring the selected keyword from the existing keyword separately from the existing keyword from the selected keyword, by generating a directional graph to estimate the values, as described next in reference to FIG. 7. This approach may be more robust and directional for the asymmetrical scenario.

FIG. 7 is a flow chart illustrating aspects of a method 700 for generating a directional graph estimate in an asymmetrical scenario, according to some example embodiments. For illustrative purposes, the method 700 is described with respect to the networked system 100 of FIG. 1. It is to be understood that the method 700 may be practiced with other system configurations in other embodiments. The operations in FIG. 7 are performed for each selected keyword and each existing keyword. The operations of FIG. 7 can be performed for predicting a traffic volume estimate, predicting a clickthrough rate estimate, or other metric. The first example described is for predicting a traffic volume estimate.

In operation 702, the computing system generates a set of documents for an existing keyword. For example, as explained above, the computing system uses the existing keyword as a query in one or more search engines to generate a set of documents for the existing keyword. The search may be conducted on public documents (e.g., the Internet), private documents (e.g., internal to a particular entity conducting the search), on specified websites or domains (e.g., a competitor's website, a related industry website), and so forth.

For instance, D1 is the set of documents for existing keyword w1. An assumption is made where each document in the set of documents D1 has the same traffic volume p (e.g., the actual traffic volume for the existing keyword w1) and by extension to decreasing the traffic volume. Then another assumption is that by searching with selected keyword w2, the computing system gets the same set of documents D1 and predicts the traffic volume q on each of the documents of D1. It is noted that when the computing device does an actual search using selected keyword w2, it gets a set of documents D2 and not D1. Since the actual traffic volume for the existing keyword w1 is known, and thus the actual traffic volume for D1 is known (and traffic volume for D2 is unknown), the computing system uses D1 to predict the traffic volume estimate for selected keyword w2. The traffic volume for D2 for selected keyword w2 is higher than that of D1. For example: TrafficVolume (w1, D1)→TrafficVolume (w2, D1)<TrafficVolume (w2, D2).

In operation 704, the computing system determines a number of sentences in the set of documents that contain the existing keyword and a number of sentences that contain the selected keyword. For example, the computing system determines an existing keyword sentence value corresponding to the number of sentences in the set of documents that contain the existing keyword and a selected keyword sentence value corresponding to the number of sentences in the set of documents that contain the selected keyword. For instance, assume one document has length n and there are k sentences containing existing keyword w1 andm sentences containing selected keyword w2. Further, the traffic volume of each sentence is the same, denoted as r. Thus, the equations are as follows:

$$1 - {( 1 - r )}^{k} = p , 1 - {( 1 - r )}^{m} = q q = 1 - exp ( \frac{m}{k} log ( 1 - p ) )$$

Where the following indicates the actual traffic volume p for existing keyword w1:

1−(1−r)ₖ=p

Where following indicates the predicted traffic volume estimate q for the selected keyword w2:

1−(1−r)^{m}=q

And where the following is the equation for determining the predicted traffic volume estimate q for the selected keyword w2:

$$q = 1 - exp ( \frac{m}{k} log ( 1 - p ) )$$

In one example, the computing system discounts the existing keyword sentence value and the selected keyword sentence value. In one example, discounting is performed by applying an inverse document frequency (IDF) discount on the existing keyword sentence value and an IDF discount on the selected keyword sentence value. For example, to make the process more robust, m and k can be discounted, which mean m is replaced with:

$$\frac{1 - exp ( \frac{m}{k} log ( 1 - p ) )}{p} V \qquad ( 1 )$$

And k can be similarly replaced. The computing system takes the average or max of (1) over all documents in D1.

In operation 706, the computing system generates a graph comprising a node for each selected keyword and each existing keyword and creates a directional link between nodes in the graph where the existing keyword sentence value divided by the selected keyword sentence value is greater than zero. For example, the computing system forms a graph by adding a node for each keyword (e.g., existing keyword and selected keyword) and creating a direction link (e.g., w1+w2) if m/k=0. In one example, the computing system uses the discounted existing keyword sentence value and the discounted selected sentence value to generate the graph.

In operation 708, the computing system generates a predicted traffic volume for each selected keyword based on the highest traffic volume from its incoming links in the graph. For example, the computing system does a breadth first search on the generated graph starting from existing keywords. At each node, the computing system updates the node's volume estimate to be the highest volume estimate from the node's incoming links, for example:

Vᵢ=max_{j,(ji) in G}aⱼᵢVⱼ (2)

Where aji is the ratio defined in (1). Note that even though A→B does not have a link, A→B→C may still be able to estimate traffic volume at C through intermediate node B.

The above method can also be used to predict the estimated clickthrough rate. In one example, the clickthrough rate of existing keyword w1 is the clickthrough rate of the ad on a document. The clickthrough rate of the existing keyword can be used as the clickthrough rate of any document in search results. The same operations of FIG. 7 and described above can be used to predict the estimated clickthrough rate, for example, to estimate the clickthrough rate of selected keyword w2 from existing keyword w1. For example, let D2 be the set of documents that result after a search using selected keyword w2. The computing system approximates the probability of clicking an ad for selected keyword w2 by the probability of clicking existing keyword w1 in D2. As explained above, k is the number of sentences in the documents in the set of documents D2 containing existing keyword w1 and m is the number of sentences in the documents in the set of documents D2 containing selected keyword w2. The clickthrough rate of searching using selected keyword w2 can be estimated as k/m*p (where p is the actual clickthrough rate of existing keyword w1). The computing system then takes the maximum clickthrough rate across all the documents in D2. Similarly, the computing device can use the same IDF discount on m and k, as described above.

As an example, if the selected keyword “temporary rental host” appears ten times in D2 and “temporary rental host in san francisco” appears five times in D2, the clickthrough rate of selected keyword w2 is 5/10=0.5*CTR of existing keyword w1. Note that in this example, the clickthrough rate is an ad clickthrough rate and not a search result clickthrough rate. The intuition behind this estimate is that when there is only a small fraction of sentences containing existing keyword w1 in D2, D2 may be irrelevant to w1 and thus the clickthrough rate will be lower. The computing device then constructs a similar graph as for the traffic estimate and generates a predicted clickthrough rate estimate on the graph (2).

As explained above, the computing system can rank the selected keywords by final predicted clickthrough rate and final predicted traffic volume.

Example embodiments allow for a single seed keyword to start with. Example embodiments then do a keyword-to-document transformation that generates a list of high-quality documents and follows with a document-to-keyword transformation to produce more relevant keywords. The loop goes on until relevant keywords are exhausted or a document space is exhausted. In one example embodiment, the process starts with a document (e.g., URL) and the loop flow is similar except that it initially starts with a document-to-keyword transformation.

Note that in example embodiments there are typically thousands, if not hundreds of thousands, of selected keywords and existing keywords. Thus, performing operations herein manually would not be mathematically possible.

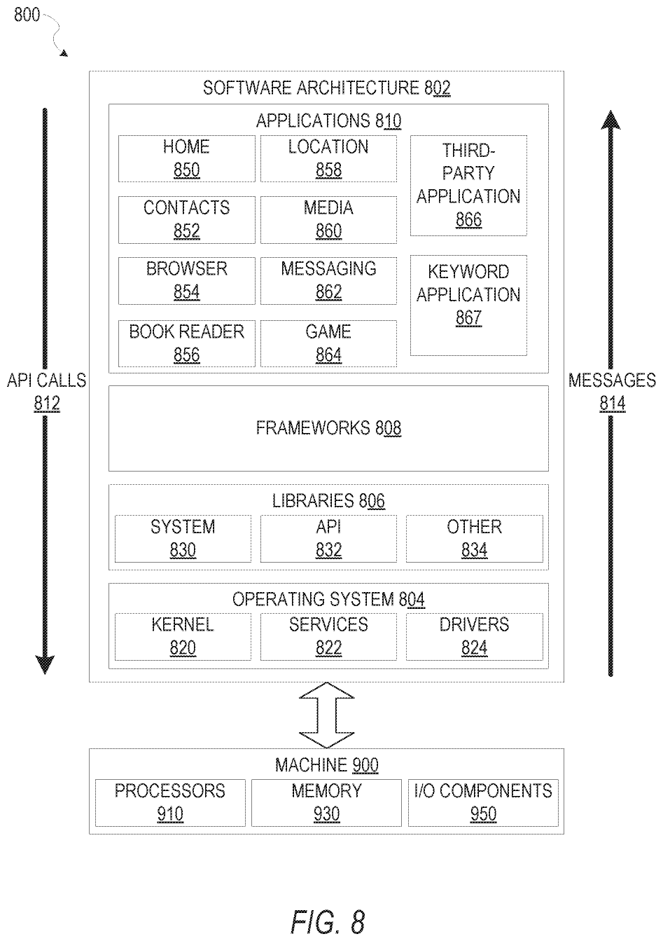

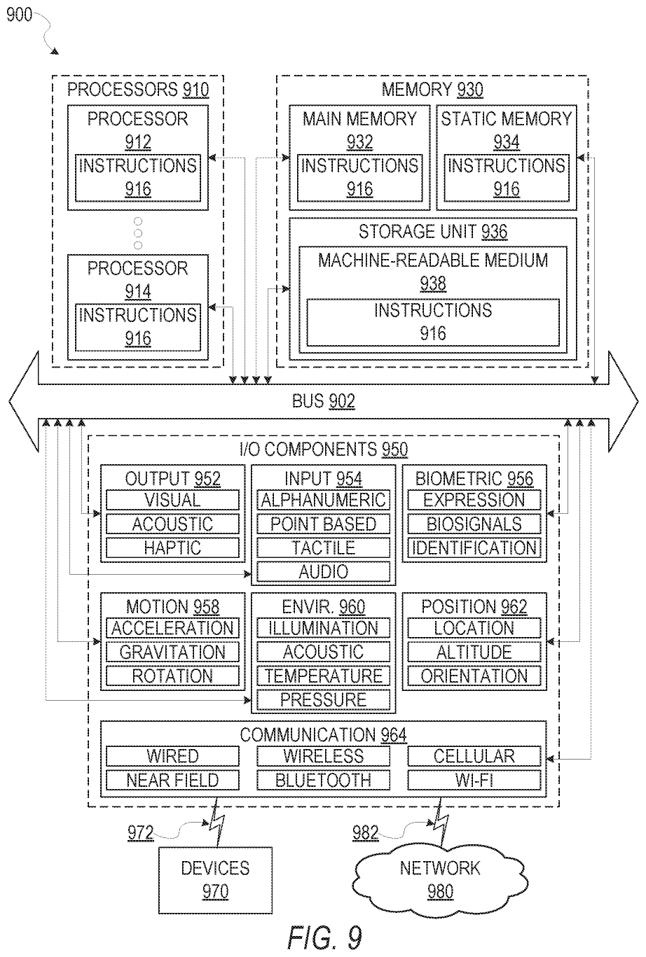

FIG. 8 is a block diagram 800 illustrating a software architecture 802, which can be installed on any one or more of the devices described above. For example, in various embodiments, client devices 110 and server systems 130, 102, 120, 122, and 128 may be implemented using some or all of the elements of the software architecture 802. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and I/O components 950. In this example, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke application programming interface (API) calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render two-dimensional (2D) and three-dimensional (3D) graphic content on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various graphic user interface (GUI) functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications such as a third-party applications 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS^{T}M, ANDROID™, WINDOWS@ Phone, or another mobile operating system. In this example, the third-party application 866 can invoke the API calls 812 provided by the operating system 804 to facilitate functionality described herein.

Some embodiments may particularly include a keyword generation application 867, which may be any application that requests data or other tasks to be performed by systems and servers described herein, such as the server system 102, third-party servers 130, and so forth. In certain embodiments, this may be a standalone application that operates to manage communications with a server system such as the third-party servers 130 or server system 102. In other embodiments, this functionality may be integrated with another application. The keyword generation application 867 may request and display various data related to keyword generation and may provide the capability for a user 106 to input data related to the system via voice, via a touch interface, via a keyboard, or using a camera device of the machine 900; communication with a server system via the I/O components 950; and receipt and storage of object data in the memory 930. Presentation of information and user inputs associated with the information may be managed by the keyword generation application 867 using different frameworks 808, library 806 elements, or operating system 804 elements operating on the machine 900.

FIG. 9 is a block diagram illustrating components of a machine 900, according to some embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application 810, an applet, an app, or other executable code) for causing the machine 900 to perform any one or more of the methodologies discussed herein can be executed. In alternative embodiments, the machine 900 operates as a standalone device or can be coupled (e.g., networked) to other machines. In a networked deployment, the machine 900 may operate in the capacity of a server machine 130, 102, 120, 122, 124, 128 and the like, or a client device 110 in a server-client network environment, or as a peer machine in a peer-to-peer (or distributed) network environment. The machine 900 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

In various embodiments, the machine 900 comprises processors 910, memory 930, and I/O components 950, which can be configured to communicate with each other via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 912 and a processor 914 that may execute the instructions 916. The term “processor” is intended to include multi-core processors 910 that may comprise two or more independent processors 912, 914 (also referred to as “cores”) that can execute instructions 916 contemporaneously. Although FIG. 9 shows multiple processors 910, the machine 900 may include a single processor 910 with a single core, a single processor 910 with multiple cores (e.g., a multi-core processor 910), multiple processors 912, 914 with a single core, multiple processors 912, 914 with multiple cores, or any combination thereof.

The memory 930 comprises a main memory 932, a static memory 934, and a storage unit 936 accessible to the processors 910 via the bus 902, according to some embodiments. The storage unit 936 can include a machine-readable medium 938 on which are stored the instructions 916 embodying any one or more of the methodologies or functions described herein. The instructions 916 can also reside, completely or at least partially, within the main memory 932, within the static memory 934, within at least one of the processors 910 (e.g., within the processor's cache memory), or any suitable combination thereof, during execution thereof by the machine 900. Accordingly, in various embodiments, the main memory 932, the static memory 934, and the processors 910 are considered machine-readable media 938.

As used herein, the term “memory” refers to a machine-readable medium 938 able to store data temporarily or permanently and may be taken to include, but not be limited to, random-access memory (RAM), read-only memory (ROM), buffer memory, flash memory, and cache memory. While the machine-readable medium 938 is shown, in an example embodiment, to be a single medium, the term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions 916, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 include a wide variety of components to receive input, provide output, produce output, transmit information, exchange information, capture measurements, and so on. In general, it will be appreciated that the I/O components 950 can include many other components that are not shown in FIG. 9. The I/O components 950 are grouped according to functionality merely for simplifying the following discussion, and the grouping is in no way limiting. In various example embodiments, the I/O components 950 include output components 952 and input components 954. The output components 952 include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 950 include biometric components 956, motion components 958, environmental components 960, or position components 962, among a wide array of other components. For example, the biometric components 956 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 include acceleration sensor components (e.g., accelerometer), gravitation sensor components, rotation sensor components (e.g., gyroscope), and so forth. The environmental components 960 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or another suitable device to interface with the network 980. In further examples, the communication components 964 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 970 may be another machine 900 or any of a wide variety of peripheral devices (e.g., a peripheral device coupled via a Universal Serial Bus (USB)).

Moreover, in some embodiments, the communication components 964 detect identifiers or include components operable to detect identifiers. For example, the communication components 964 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI@ signal triangulation, location via detecting a BLUETOOTH@ or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 916 are transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, in other example embodiments, the instructions 916 are transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Furthermore, the machine-readable medium 938 is non-transitory (in other words, not having any transitory signals) in that it does not embody a propagating signal. However, labeling the machine-readable medium 938 “non-transitory” should not be construed to mean that the medium is incapable of movement; the medium 938 should be considered as being transportable from one physical location to another. Additionally, since the machine-readable medium 938 is tangible, the medium 938 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method, comprising:
receiving, by a computing system, a seed keyword;
using, by the computing system, the seed keyword as a query in one or more search engines to generate a plurality of documents for the seed keyword;
analyzing, by the computing system, each document of the plurality of documents to extract words for each sentence in each document of the plurality of documents;
generating, by the computing system, candidate keywords from the extracted words;
determining, by the computing system, a frequency that each candidate keyword appears in a particular document of the plurality of documents and a frequency with which each candidate keyword appears across all of the plurality of documents;
ranking, by the computing system, the candidate keywords by the frequency with which each candidate keyword appears in a particular document of the plurality of documents and the frequency with which each candidate keyword appears across all of the plurality of documents;
providing, by the computing system, the ranked candidate keywords to a computing device;
receiving, by the computing system, a selection of the ranked candidate keywords to store as selected keywords; and
storing, by the computing system, the selected keywords.

2. The method of claim 1, wherein the query in one or more search engines is conducted on private data internal to one or more entities and public data.

3. The method of claim 1, further comprising, for each of the selected keywords, repeating the following operations until a predetermined number of interactions is reached or until a predetermined number of total selected keywords is reached:
using the selected keyword as a query in one or more search engines to generate a plurality of documents for the selected keyword;
analyzing each document of the plurality of documents to extract words for each sentence in each document of the plurality of documents;
generating candidate keywords from the extracted words;
determining a frequency with which each candidate keyword appears in a particular document of the plurality of documents and a frequency with which each candidate keyword appears across all of the plurality of documents;
ranking the candidate keywords by the frequency with which each candidate keyword appears in a particular document of the plurality of documents and the frequency with which each candidate keyword appears across all of the plurality of documents;
providing the ranked candidate keywords to a computing device;
receiving a selection of the ranked candidate keywords to store as selected keywords; and
storing the selected keywords.

4. The method of claim 1, further comprising:
generating a set of documents for a first selected keyword and a set of documents each of a plurality of existing keywords;
generating a set of words for each document of the set of documents for the first selected keyword and a set of words for each document of the set of documents for each of the plurality of existing keywords;
generating a matrix comprising pairs of sets of words, each pair comprising the set of words for the first selected keyword and a set of words for an existing keyword; and
generating a similarity ratio for the selected keyword for each existing keyword based on the generated matrix.

5. The method of claim 4, further comprising:
for each of the existing keywords, applying the similarity ratio for the first selected keyword to an actual clickthrough rate and an actual traffic volume corresponding to the existing keyword to generate a predicted clickthrough rate and a predicted traffic volume for the selected keyword; and
storing the predicted clickthrough rate and the predicted traffic volume for the selected keyword.

6. The method of claim 5, further comprising:
ranking the selected keywords by predicted clickthrough rate and predicted traffic volume.

7. The method of claim 1, further comprising, for each selected keyword and each existing keyword:
generating a set of documents for the existing keyword;
determining an existing keyword sentence value corresponding to a number of sentences in the set of documents that contain the existing keyword and a selected keyword sentence value corresponding to the number of sentences in the set of documents that contain the selected keyword;
generating a graph comprising a node for each selected keyword and each existing keyword and creating a directional link between nodes in the graph where the existing keyword sentence value divided by the selected keyword sentence value is greater than zero; and
generating a predicted clickthrough rate of the selected keyword based on the highest clickthrough rate from its incoming links in the graph.

8. The method of claim 7, further comprising:
discounting the existing keyword sentence value and the selected keyword sentence value; and
using the discounted existing keyword sentence value and the discounted selected sentence value to generate the graph.

9. The method of claim 8, wherein the discounting is performed by applying an inverse document frequency discount on the existing keyword sentence value and an inverse document frequency discount on the selected keyword sentence value.

10. The method of claim 1, further comprising, for each selected keyword and each existing keyword:
generating a set of documents for the existing keyword;
determining an existing keyword sentence value corresponding to a number of sentences in the set of documents that contain the existing keyword and a selected keyword sentence value corresponding to the number of sentences in the set of documents that contain the selected keyword;
generating a graph comprising a node for each selected keyword and each existing keyword and creating a directional link between nodes in the graph where the existing keyword sentence value divided by the selected keyword sentence value is greater than zero; and
generating a predicted traffic volume of the selected keyword based on the highest traffic volume from its incoming links in the graph.

11. A system comprising:
a memory that stores instructions; and
one or more processors configured by the instructions to perform operations comprising:
receiving a seed keyword;
using the seed keyword as a query in one or more search engines to generate a plurality of documents for the seed keyword;
analyzing each document of the plurality of documents to extract words for each sentence in each document of the plurality of documents;
generating candidate keywords from the extracted words;
determining a frequency with which each candidate keyword appears in a particular document of the plurality of documents and a frequency with which each candidate keyword appears across all of the plurality of documents;
ranking the candidate keywords by the frequency with which each candidate keyword appears in a particular document of the plurality of documents and the frequency with which each candidate keyword appears across all of the plurality of documents;
providing the ranked candidate keywords to a computing device;
receiving a selection of the ranked candidate keywords to store as selected keywords; and
storing the selected keywords.

12. The system of claim 11, further comprising, for each of the selected keywords, repeating the following operations until a predetermined number of interactions is reached or until a predetermined number of total selected keywords is reached:
using the selected keyword as a query in one or more search engines to generate a plurality of documents for the selected keyword;
analyzing each document of the plurality of documents to extract words for each sentence in each document of the plurality of documents;
generating candidate keywords from the extracted words;
determining a frequency with which each candidate keyword appears in a particular document of the plurality of documents and a frequency with which each candidate keyword appears across all of the plurality of documents;
ranking the candidate keywords by the frequency with which each candidate keyword appears in a particular document of the plurality of documents and the frequency with which each candidate keyword appears across all of the plurality of documents;
providing the ranked candidate keywords to the computing device;
receiving a selection of the ranked candidate keywords to store as selected keywords; and
storing the selected keywords.

13. The system of claim 11, the operations further comprising:
generating a set of documents for a first selected keyword and a set of documents each of a plurality of existing keywords generating a set of words for each document of the set of documents for the first selected keyword and a set of words for each document of the set of documents for each of the plurality of existing keywords;
generating a matrix comprising pairs of sets of words, each pair comprising the set of words for the first selected keyword and a set of words for an existing keyword; and
generating a similarity ratio for the selected keyword for each existing keyword based on the generated matrix.

14. The system of claim 13, the operations further comprising:
for each of the existing keywords, applying the similarity ratio for the first selected keyword to an actual clickthrough rate and an actual traffic volume corresponding to the existing keyword to generate a predicted clickthrough rate and a predicted traffic volume for the selected keyword; and
storing the predicted clickthrough rate and the predicted traffic volume for the selected keyword.

15. The system of claim 14, the operations further comprising:
ranking the selected keywords by predicted clickthrough rate and predicted traffic volume.

16. The system of claim 11, the operations further comprising, for each selected keyword and each existing keyword:
generating a set of documents for the existing keyword;
determining an existing keyword sentence value corresponding to a number of sentences in the set of documents that contain the existing keyword and a selected keyword sentence value corresponding to the number of sentences in the set of documents that contain the selected keyword;
generating a graph comprising a node for each selected keyword and each existing keyword and creating a directional link between nodes in the graph where the existing keyword sentence value divided by the selected keyword sentence value is greater than zero; and
generating a predicted clickthrough rate of the selected keyword based on the highest clickthrough rate from its incoming links in the graph.

17. The system of claim 16, the operations further comprising:
discounting the existing keyword sentence value and the selected keyword sentence value; and
using the discounted existing keyword sentence value and the discounted selected sentence value to generate the graph.

18. The system of claim 17, wherein the discounting is performed by applying an inverse document frequency discount on the existing keyword sentence value and an inverse document frequency discount on the selected keyword sentence value.

19. The system of claim 11, the operations further comprising, for each selected keyword and each existing keyword:
generating a set of documents for the existing keyword;
determining an existing keyword sentence value corresponding to a number of sentences in the set of documents that contain the existing keyword and a selected keyword sentence value corresponding to the number of sentences in the set of documents that contain the selected keyword;
generating a graph comprising a node for each selected keyword and each existing keyword and creating a directional link between nodes in the graph where the existing keyword sentence value divided by the selected keyword sentence value is greater than zero; and
generating a predicted traffic volume of the selected keyword based on the highest traffic volume from its incoming links in the graph.

20. A non-transitory computer-readable medium comprising instructions stored thereon that are executable by at least one processor to cause a computing device associated with a first data owner to perform operations comprising:
receiving a seed keyword;
using the seed keyword as a query in one or more search engines to generate a plurality of documents for the seed keyword;
analyzing each document of the plurality of documents to extract words for each sentence in each document of the plurality of documents;
generating candidate keywords from the extracted words;
determining a frequency with which each candidate keyword appears in a particular document of the plurality of documents and a frequency with which each candidate keyword appears across all of the plurality of documents;
ranking the candidate keywords by the frequency with which each candidate keyword appears in a particular document of the plurality of documents and the frequency with which each candidate keyword appears across all of the plurality of documents;
providing the ranked candidate keywords to a computing device;
receiving a selection of the ranked candidate keywords to store as selected keywords; and
storing the selected keywords.
